(19) United States
(12) Patent Application Publication
(10) Pub. No.: US 2012/0286026 A1
(43) Pub. Date: Nov. 15, 2012

(54) WIRE SOLDER, METHOD OF FEEDING THE SAME AND APPARATUS THEREFOR

(75) Inventor: Tetsuro Nishimura, Osaka (JP)

(73) Assignee: NIHON SUPERIOR CO., LTD., Osaka (JP)

(21) Appl. No.: 13/469,745

(22) Filed: May 11, 2012

Related U.S. Application Data
(62) Division of application No. 13/144,328, filed on Jul. 13, 2011.

(30) Foreign Application Priority Data
Jan. 19, 2009 (JP) 2009-008930

(51) Int. Cl. B23K 1/00

(52) U.S. Cl. 228/256

(57) ABSTRACT

Provided is a solder with high tensile strength and pull cut resistance. The wire solder has an extended wire solder and a core wire having a higher tensile strength than the wire solder. The wire solder has a single or multiple strands bound together. The wire solder is supplied from upstream of a location of soldering while the core wire is rewound under tension at a location downstream of the location of soldering.

### TECHNICAL FIELD

The present invention relates to wire solder including a core wire and a supplying device therefor, and relates to wire solder having tensile resistance by combining wire solder that easily breaks by a small force with a core wire of high tension. The present invention further relates to a method and a device for supplying the wire solder for soldering.

### BACKGROUND ART

Conventionally wire solder that is linearly processed solder alloy or flux cored wire solder containing a flux component inside the wire solder typically is used as means for mounting electronic components such as a resistor, a capacitor and an IC on a printed circuit board, and these electronic components are jointed to the board by melting the solder using a soldering iron.

Wire solder, however, has drawbacks of soft and deforming easily because of its shape and characteristics, and therefore supplying devices of solder have been devised variously. Further, as electronic components have been miniaturized lately, the diameter of wire solder used also has become thinner dramatically, and wire solder of 0.1 mm or thinner in diameter also is used these days. Such a type of wire solder, however, easily breaks under a tension, and so a method for supplying wire solder to a joint part stably and a device for supplying wire solder stably have been required.

Recently proposed devices for supplying wire solder include, for example, a device for automatically supplying thin wire solder (Patent Document 1) and a wire solder supplying device for manual soldering to insert wire solder easily (Patent Document 2). Examples of solder for stable supply and connection include solder including a plurality of pieces of wire solder twined (Patent Document 3) and solder including a metal wire (Patent Document 4).

The device of Patent Document 1 feeds a solder wire and the device of Patent Document 2 has a mechanism to feed a solder wire similarly to Patent Document 1, and, however, it is practically difficult for these devices to supply soft solder wires speedily and precisely to a determined position. The solder proposed by Patent Document 3, which includes a plurality of pieces of wire solder twined, is not suitable for the recent mounting of electronic components requiring thinner wire diameter, and also has a problem to be solved in terms of stable supply. The solder proposed by Patent Document 4, which is obtained by processing a lead wire with solder, is not suitable for means to mount electronic components such as a resistor, a capacitor and an IC on a printed circuit board. It is also difficult for Patent Document 4 to improve the tension of the wire solder itself.

### RELATED ART DOCUMENTS

### Patent Documents

Patent document 1: Japanese Open Gazette No. H5-245627
Patent document 2: WO 05/515
Patent document 3: Japanese Open Gazette No. 2007-98455
Patent document 4: Japanese Open Gazette No. H9-1380

### DISCLOSURE OF INVENTION

### Problems to be Solved by the Invention

It is an object of the present invention to disclose a configuration to prevent easy break of wire solder even when using soft wire solder, and to further disclose a supplying method and a supplying device capable of supplying this wire solder precisely and effectively.

### Means for Solving the Problems

In order to fulfill the above-stated object, the present invention firstly uses wire solder including a solder wire extended linearly and a core wire having tensile resistance higher than that of the solder wire. Although wire solder conventionally used does not have tensile resistance and easily breaks, the core wire having a tension higher than that of the solder wire is provided at a center portion in the same direction as the solder wire, whereby the tensile resistance of the core wire serves as tensile resistance of the wire solder as a whole, and the position of solder can be easily controlled by pulling the wire solder in the drawing-out direction while applying a tensile force to the core wire. The wire solder may include one wire and a bundle of a plurality of wires, both of which are included in the present invention.

The core wire may be made of a thermosetting resin that does not change in quality at an operating temperature of the solder wire, selected from the group consisting of phenol resin, epoxy resin, melamine resin, aromatic polyamide-based resin (e.g., Kevle: registered trademark of DuPont), carbon fiber and polyimide-based resin. The configuration of such a resin as the core wire may be embodied by means of putting uncured resin at a portion corresponding to a core in a similar manner to putting flux during the manufacturing of wire solder. Thereafter, the resin is cured by heating, whereby a core wire allowing a solder wire to be pulled can be obtained.

As another means, the core wire may include a material that generates heat with Joule heat such as a tungsten wire, a stainless steel wire, a piano wire, an iron wire, an aluminum wire or a copper wire. In this case, instead of the conventional way of melting solder by a soldering iron, Joule heat may be generated at the core wire by an appropriate well-known means, whereby the wire solder melts from a portion close to the core wire, and insufficient melting due to insufficient heating can be prevented. Additionally, such a core wire has high tensile resistance and can exert a function of the core wire demanded by claim 1 sufficiently.

As still another configuration of the wire solder, a plurality of solder wires may be bound, while providing a core wire having tensile resistance higher than that of the solder wires in the same direction as the solder wires. According to this configuration, solder wires can be manufactured by conventionally well-known techniques and a plurality of the solder wires can be bound or braided like a rope as one composite solder wire, thus leading to advantages of easy manufacturing as well as improvement of a tensile strength because of the core wire included. Herein, the core wire may be braided similarly to other plurality of solder wires or solder wires may be braided around the core wire as a core.

The solder wire may selectively include flux cored wire solder including flux along a center axis (at a core portion). Since flux is provided at the core of the solder wire, there is no need to provide rosin or flux separately, thus facilitating the soldering.

Such wire solder may be supplied by drawing out wire solder before use that is wound around a reel in a typical manner while applying a tensile force to the core wire, and solder is heated and melted at a predetermined position for soldering. In the present invention, a side before use for soldering is called upstream and a side for collecting core wire after soldering is called downstream with reference to the predetermined position for soldering.

A supplying device for such wire solder includes: a solder storage that stores wire solder or a wire solder bundle; and a core wire storage that stores the core wire while collecting the core wire from a front end side of the wire solder. According to the device, while the core wire storage is rotated to collect the core wire, the wire solder or the wire solder bundle is partially heated upstream of the collecting to melt solder for soldering. More specifically, the core wire storage may have a reel structure, and may be rotated by motor driving to collect the core wire. This device can be relatively compact, and is applicable to both of manual operation and automatic operation.

### Advantages

Wire solder according to the present invention can securely avoid easy break of wire solder because of a core wire combined therewith, the core wire having tensile resistance and to which tension can be applied during rewinding and drawing-out. A supplying method and a supplying device for wire solder of the present invention enable easy and precise supplying of wire solder to a soldering portion without influences of types of solder alloy or the diameter of wire solder. In other words, although using a solder wire resistant to cutting, such a method and device enable automatic soldering, and therefore operability for mounting of electronic components can be improved and cost also can be reduced.

When the wire solder bundle of the present invention is used, a bundle of wire solder having a plurality of types of compositions can be supplied, and therefore effects of suppressing and controlling joint malfunctions can be expected, such as voids occurring during soldering.

The material that generates heat with Joule heat as a core enables local heating, and therefore thermal energy can be given only to an extremely small portion for soldering, thus alleviating thermal load to electronic components subject to soldering and so suppressing degradation of electronic components due to high temperatures.

### BRIEF DESCRIPTION OF THE DRAWINGS

FIG. 1 is a cross-sectional view illustrating exemplary wire solder of the present invention.

FIG. 2 is a cross-sectional view illustrating another example.

FIG. 3 is a cross-sectional view illustrating still another example.

FIG. 4 schematically illustrates an exemplary wire solder supplying device of the present invention.

### BEST MODE FOR CARRYING OUT THE INVENTION

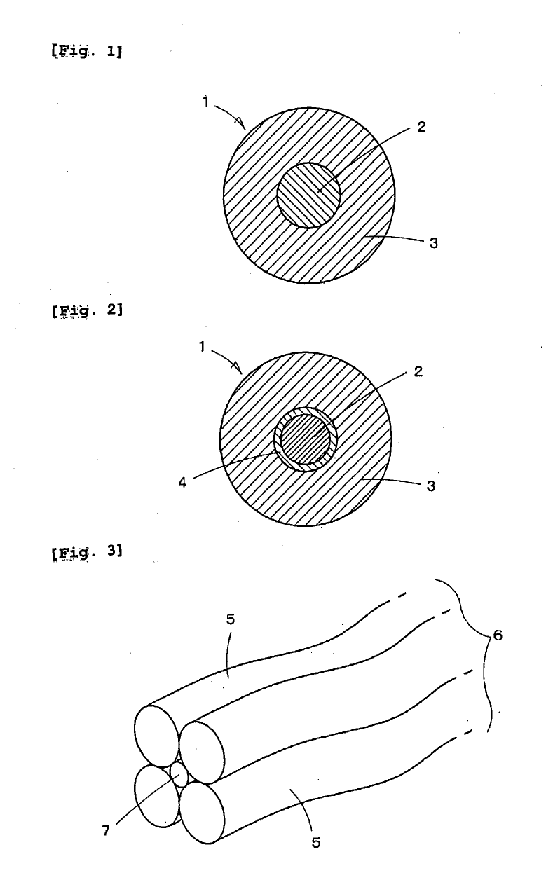

To begin with, one embodiment of wire solder according to the present invention is described. FIG. 1 is a cross-sectional view of wire solder 1 of the present invention, where numeral 2 denotes a core wire and 3 denotes a solder wire. The wire solder includes the core wire 2 as a core of the solder wire 3. The core wire 2 does not have to be strictly positioned at the center of the solder wire 3, but it is understood that the core wire 2 is surrounded with solder alloy. The configuration of the solder wire 3 made of solder alloy missed partially, thus partially exposing the core wire 2, does not have to be excluded. The alloy composition making up the solder wire 3 has any composition as long as the solder wire can function as solder. FIG. 2 illustrates the configuration including flux 4 in addition to the configuration of FIG. 1, where the flux may be contained by conventionally well-known means.

The core wire 2 is made of a high tension material resistant to a method of dragging or pulling from downstream via a soldering position. A tensile-resistant strength does not have to be limited numerically, but may be strong enough not to break easily by a force pulling the core wire 2 toward downstream when operating the wire solder 1. In this manner, the core wire 2 with an extremely small-diameter can be used by selecting a material thereof.

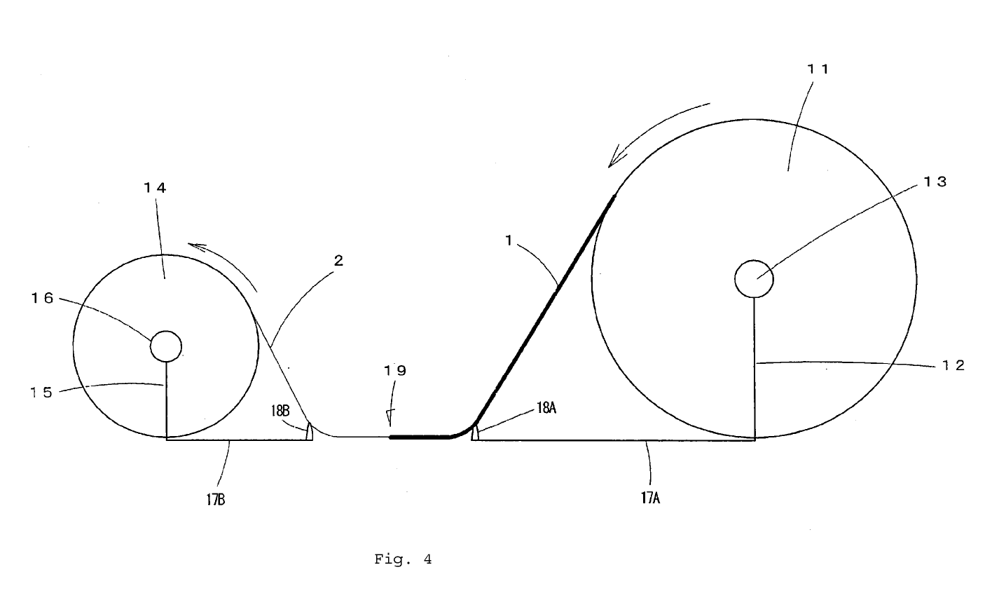

FIG. 3 illustrates wire solder of another embodiment, including a wire solder bundle 6 made up of a plurality of pieces of wire solder 5 twined, each including solder alloy and flux such as rosin, as well as a high tension core wire 7. The wire solder 5 and the core wire 7 have a relationship such that a plurality of pieces of wire solder are twined around the core wire 7 at a center or the wire solder 5 and the core wire 7 are braided, both of which are naturally included in the present invention, and the specific configuration to make the wire solder bundle 6 one bundle is not limited to these embodiments.

The shape and the size of wire solder of the present invention are not limited especially within a range of effects expected from the present invention. For instance, as for a cross-sectional shape, shapes such as round, oval and polygon can be selected depending on the purpose, and as for a thickness as well, a range of thickness that is generally available can be used without problem, and a wire diameter of 100 μm or less also is possible. As for the wire solder bundle 6 as well, the number of pieces of wire solder 5 and a method for bundling are not limited especially. The core wire 7 is disposed at a center portion, around which resin such as rosin may be provided and then a plurality of pieces of wire solder may be fixed therearound. Alternatively, two pieces of wire solder 5 and a core wire 7 with a diameter of equal to or less than that of the wire solder 5 may be braided in three strands.

The composition of solder alloy used for the wire solder of the present invention is not limited as stated above. Considering environmental issues, preferable compositions for the solder alloy include lead-free solder such as Sn—Cu alloy and Sn—Ag alloy. Even solder containing Pb, however, does not affect the present invention substantially.

The core wires 2 and 7 used in the present invention are requested to have high tension and do not change in quality at soldering temperatures so as to have the effects of the present invention, and a thermosetting resin or a material that generates Joule heat may be disclosed for this purpose, for example. The core wires 2 and 7 are requested to have tension that does not easily break in a method of dragging or pulling the core wire when supplying wire solder, and other properties are not limited especially within a range of not impairing soldering. The core wires 2 and 7 are requested to have a heat resistant property that does not change in quality at temperatures during soldering, and one that does not change in quality at a temperature around 400° C. that is slightly higher than 370° C. as a temperature of a soldering tip typically used for soldering of lead-free solder may be used without problem. Note here that, when a low melting point solder alloy is used for the wire solder, a temperature lower than the above-stated temperature may be set at a limit temperature for quality change without problem.

As for the materials of the core wires 2 and 7 illustrated above, exemplary thermosetting resins include phenol resin, epoxy resin, melamine resin and the like. In the case of a thermosetting resin, the resin should be made of a material that cures at a temperature lower than a solder melting point, and a standard curing temperature is preferably lower than about 130° C. that is a melting point of a typical low melting point solder. Exemplary materials that generate Joule heat include a tungsten wire, a stainless steel wire, a piano wire, an iron wire, an aluminum wire, a copper wire and the like that generate heat by high-frequency heating, current or the like as one type of Joule heat.

A manufacturing method of the wire solder of the present invention is not limited especially as long as the effects of the present invention can be obtained therefrom, and a conventional method or device for manufacturing wire solder can be used. When a thermosetting resin is used as the core wire, the following method is available, for example. That is, wire solder is prepared in a cylindrical hollow shape in advance, and thereafter an end of this wire solder is simmered in a thermosetting resin phase such as epoxy resin in a fluid state, and pressure in the wire solder is reduced from the other end so as to suck the epoxy resin serving as a core wire into the wire solder, thus filling the wire solder with the resin. Thereafter heat processing is performed so as to cure the resin filled in the wire solder, which is then processed in any wire diameter using a tool such as a dies. When a material that generates Joule heat, e.g., a piano wire, is used, a piano wire processed in a designated wire diameter beforehand may be surrounded with solder alloy, which is then processed in any wire diameter. Alternatively, the piano wire may be wound around a solder wire or may be embedded in a solder wire.

As for the wire solder bundle of the present invention, each piece of wire solder making up the bundle may have a different solder alloy composition and flux composition, a plurality of pieces of wire solder may include the same material, each piece of wire solder may have a different thickness, or each piece of wire solder may have a different thickness and a different composition by combining the above-stated pieces of wire solder. For instance, the bundle may include two types or more of wire solder each having an alloy composition with a different melting point. With a plurality of combinations of alloy compositions and flux compositions used, problems of jointing, such as voids occurring during joint operation can be suppressed or controlled, or a joint strength can be improved.

### EXAMPLES

In order to verify that wire solder of the present invention has an excellent tensile strength and does not easily break under the application of tension, two samples and three comparative samples were prepared as in the manner of Table 1, each being made at the length of 15 cm, to which a tensile force was applied while fixing at both ends. Experiment was conducted at a room temperature (20° C.) and with a tensile speed of 50 mm/min. The composition of solder wire was Sn-0.7Cu-0.05Ni with a very small quantity of Ge added thereto, and a piano wire was used as a core wire. The samples were prepared in a manner such that three solder wires were braided as well as one core wire, basically using in FIG. 3. On the other hand, the comparative samples each included a single wire.

TABLE 1

| | |
|---|---|
| Sample. 1 | three wire solder of Sn—0.7Cu—0.05Ni of |
| | φ0.1 mm + one piano wire of φ30 μm |
| Sample. 2 | three wire solder of Sn—0.7Cu—0.05Ni of |
| | φ0.3 mm + one piano wire of φ50 μm |
| Comparative | one wire solder of Sn—0.7Cu—0.05Ni of |
| Sample. 1 | φ0.1 mm |
| Comparative | one wire solder of Sn—0.7Cu—0.05Ni of |
| Sample. 2 | φ0.3 mm |
| Comparative | one wire solder of Sn—0.7Cu—0.05Ni of |
| Sample. 3 | φ0.5 mm |

In the tensile test, a maximum test force (gf) where wire solder broke was found, and Table 2 shows an average of five measurement results for each of the samples.

TABLE 2

| | tensile strength (gf) |
|---|---|
| Sample. 1 | 253.7 |
| Sample. 2 | 878.2 |
| Comparative | 20.7 |
| Sample. 1 | |
| Comparative | 165.6 |
| Sample. 2 | |
| Comparative | 466.3 |
| Sample. 3 | |

It is clear from Table 2 that the samples with a core wire added thereto, whether the solder wire diameter was 0.1 mm or 0.3 mm, had a tensile-resistant strength much larger than values three times the measurement values of the comparative samples as a single wire.

Based on the results of Table 2, Table 3 shows a comparison between Sample 1 and Comparative Sample 2 and a comparison between Sample 2 and Comparative Sample 3, while focusing attention on a cross-sectional area of solder wires. π=3.14 was used for calculation.

TABLE 3

| | | tensile |
|---|---|---|
| | total cross-sectional area | strength |
| | (not including piano wire) | (gf) |
| Sample. 1 | 0.02355 mm² | 253.7 |
| Comparative | 0.07065 mm² | 165.6 |
| Sample. 2 | | |
| Sample. 2 | 0.21195 mm² | 878.2 |
| Comparative | 0.19625 mm² | 466.3 |
| Sample. 3 | | |

The result of Table 3 shows that, although the total cross-sectional area of Sample 1 is about one third of the cross-sectional area of Comparative Sample 2, the former has a large tensile strength because of the piano wire included, and that, although the total cross-sectional area of Sample 2 is slightly larger than the cross-sectional area of Comparative Sample 3, the former has a tensile strength about twice the latter. Accordingly, the present invention, even with a solder wire at one-thinner level, can guarantee the tensile strength, and therefore soldering is enabled at a narrower portion without the danger of a break in the wire.

According to a wire solder supplying method of the present invention, wire solder is supplied to a soldering position by dragging or pulling a core wire of high tension from downstream via the soldering position. As long as wire solder is supplied to a soldering position by dragging or pulling the core wire from downstream, a position or a direction for guiding the core wire or for dragging or pulling the core wire is not limited especially.

FIG. 4 illustrates an exemplary device of the present invention of supplying wire solder to a soldering position, which is applicable to wire solder in all embodiments of the present invention. In this drawing, numeral 11 denotes a solder storage having a reel structure to store the wire solder 1, 12 denotes a strut that rotatably supports a center shaft 13 of the solder storage 11, 14 denotes a core wire storage that has a reel structure to store the core wire 2, and 15 denotes a strut that rotatably supports a center shaft 16 of the core wire storage 14. The struts 12 and 15 are stably provided at bases 17A and 17B respectively, and these bases may be common to the struts. Numerals 18A and 18B denote gates to linearly hold the wire solder and the core wire respectively, at a center portion of which is an area 19 where soldering is performed. Herein, the reel of the solder storage 11 is not driven and freely rotates, whereas the reel of the core wire storage 14 is driven. Although the driving force may be manually given, the rotation can be controlled precisely by a step motor or a servo motor.

In the above-stated wire solder supplying device of the present invention, the rotation of the core wire storage 14 lets the wire solder 1 out from the solder storage 11, which is then supplied to the area 19 where soldering is performed via the gate 18A. When soldering is completed, the core wire only passes through the gate 18B and is stored to the core wire storage 14. In this case, the gates 18A and 18B have a function of supplying the wire solder 1 to the area 19 precisely, and Teflon(Trademark) coating applied to the surface of the gates 18A and 18B enables smooth supplying of the wire solder 1 without scratches occurring on the wire solder 1.

### INDUSTRIAL APPLICABILITY

Wire solder, a wire solder supplying method and a wire solder supplying device of the present invention allow wire solder to be supplied to a soldering position simply and precisely. Further, the present invention is applicable irrespective of the composition of ingredients in wire solder, and therefore is widely applied to the mounting of electronic components.

### REFERENCE NUMERALS

1 Wire solder
2 Core wire
3 Solder wire
4 Flux

1. A solder supplying method, comprising the steps of:
positioning a wire solder comprising a solder wire extended linearly and a core wire having tensile resistance higher than that of the solder wire on an upstream side with reference to a desired soldering position; and
supplying solder to a soldering portion while giving a tensile force to the core wire from a downstream side of the soldering position.

2. The solder supplying method according to claim 1, wherein the core wire comprises a thermosetting resin that does not change in quality at a joint temperature of the solder wire.

3. The solder supplying method according to claim 2, wherein the core wire comprises at least one resin selected from the group of phenol resin, epoxy resin, melamine resin, aromatic polyamide-based resin, carbon fiber and polyimide-based resin.

4. The solder supplying method according to claim 1, wherein the core wire comprises a material that generates Joule heat.

5. The solder supplying method according to claim 4, wherein the core wire comprises at least one metal wire selected from the group consisting of a tungsten wire, a stainless steel wire, a piano wire, an iron wire, an aluminum wire and a copper wire.

6. The solder supplying method according to claim 1, wherein the wire solder comprises a bundle of a plurality of solder wires.

7. The solder supplying method according to claim 1, wherein the solder wire comprises a flux cored solder wire including flux along a center axis.

8. The solder supplying method according to claim 1, wherein the core wire has a higher melting temperature than that of the solder wire so that the core wire tolerates heating.
